(19) United States
(12) Patent Application Publication
(10) Pub. No.: US 2025/0172783 A1
(43) Pub. Date: May 29, 2025

(54) OPTICAL APPARATUS AND ITS CONTROL METHOD

(71) Applicant: CANON KABUSHIKI KAISHA, Tokyo (JP)

(72) Inventor: MASAMI ICHINOSE, Kanagawa (JP)

(21) Appl. No.: 18/952,868

(22) Filed: Nov. 19, 2024

(30) Foreign Application Priority Data
Nov. 28, 2023 (JP) 2023-200799

(51) Int. Cl. G02B 7/08; G02B 7/28

(52) U.S. Cl. CPC G02B 7/08; G02B 7/28

(57) ABSTRACT

An optical apparatus includes a first operation unit operable to switch between a first mode for setting a driving range of a focus lens in autofocus to a first range and a second mode for setting the driving range to a second range narrower than the first range, a second operation unit operable to issue a start command of a focus limit operation for limiting the driving range to the second range in the second mode, and a processor configured to set the second range to a range that has a reference position at a position of the focus lens when the start command is issued or a position to which the focus lens is driven by the autofocus after the start command is issued, and control driving of the focus lens by the autofocus within the second range after the second range is set.

### BACKGROUND

### Technical Field

The present disclosure relates to an optical apparatus such as a lens apparatus that controls movement of a focus lens.

### Description of Related Art

Japanese Patent Laid-Open No. 2013-007839 discloses a lens apparatus that reduces the focusing time by limiting a driving range of a focus lens. More specifically, in a manual focus (MF) mode, a user rotates a focus operation ring to move the focus lens to a reference position, and then switches the MF mode to an autofocus (AF) mode. In the AF mode, the focus lens is driven by AF within a predetermined driving range including the reference position to obtain an in-focus state.

### SUMMARY

An optical apparatus according to one aspect of the disclosure includes a first operation unit operable to switch between a first mode for setting a driving range of a focus lens in autofocus to a first range and a second mode for setting the driving range of the focus lens in the autofocus to a second range narrower than the first range, a second operation unit operable to issue a start command of a focus limit operation for limiting the driving range to the second range in the second mode, and a processor configured to set the second range to a range that has a reference position at a position of the focus lens when the start command is issued or a position to which the focus lens is driven by the autofocus after the start command is issued, according to the start command in a case where the focus lens can be driven by the autofocus and the second mode is set, and control driving of the focus lens by the autofocus within the second range after the second range is set. A control method corresponding to the above optical apparatus also constitutes another aspect of the disclosure.

Further features of the disclosure will become apparent from the following description of embodiments with reference to the attached drawings.

### BRIEF DESCRIPTION OF THE DRAWINGS

FIG. 1 is a block diagram illustrating the configuration of a camera system according to a first embodiment.

FIG. 2 illustrates transitions in a focus state in a lens apparatus according to the first embodiment.

FIG. 3 illustrates a driving range of a focus lens in the first embodiment.

FIG. 4 illustrates driving ranges 1 to 3 of the focus lens in the first embodiment.

FIG. 5 illustrates focus lens control according to a second embodiment.

FIG. 6 illustrates communication between a camera and a lens and the focus lens control according to the second embodiment.

FIG. 7 illustrates the switch arrangement in a lens apparatus according to a third embodiment.

FIG. 8 is a flowchart illustrating processing in a limited AF state in the first embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a programmable processor (e.g., a CPU) that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

### First Embodiment

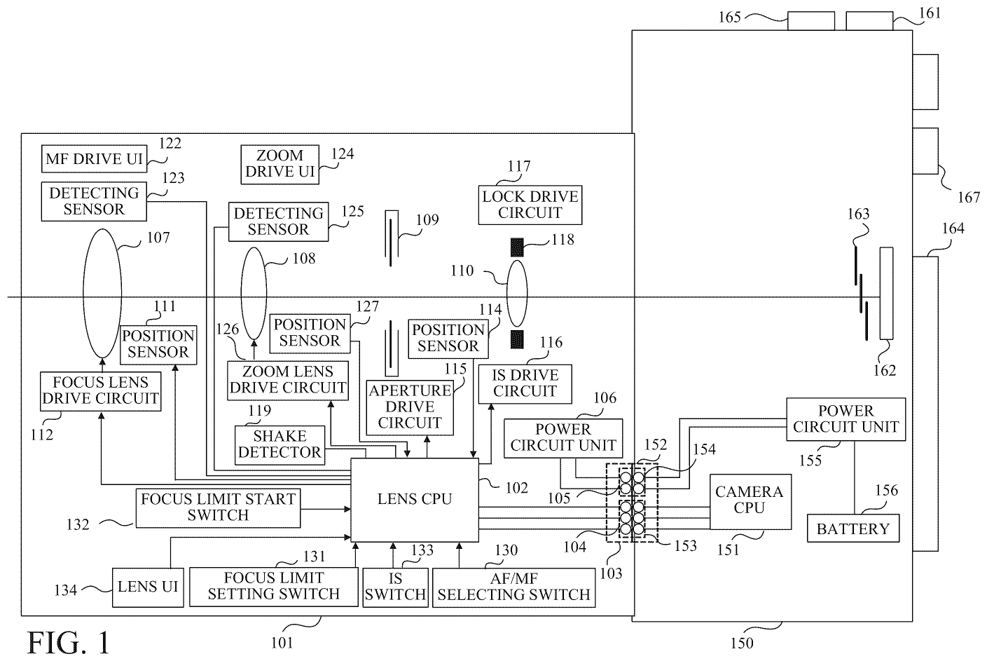

FIG. 1 illustrates the configuration of a camera system including an interchangeable lens 101 as an optical apparatus (lens apparatus) according to a first embodiment and a digital camera (simply referred to as camera hereinafter) 150. The interchangeable lens 101 is attachable to and detachable from the camera 150, and can communicate with the camera 150 via a communication terminal 104 in a lens contact unit 103 provided on a lens-side mount and a communication terminal 153 in a camera contact unit 152 provided on a camera-side mount. A power supply circuit unit 106 in the interchangeable lens 101 receives power from a power supply circuit unit 155 in the camera 150 via a power supply terminal 105 in the lens contact unit 103 and a power supply terminal 154 in the camera contact unit 152.

The power supply circuit unit 155 in the camera 150 uses power from a battery 156 attached to the camera 150 to generate various power supplies for the camera 150 and power supplies to be supplied to the interchangeable lens 101. The power supply circuit unit 106 in the interchangeable lens 101 generates various power supplies in the interchangeable lens 101 using the power supplied from the camera 150.

The interchangeable lens 101 includes an imaging optical system including a focus lens 107, a zoom (magnification varying) lens 108, an aperture stop (diaphragm) 109, and a correction lens (image stabilizing lens or shift lens) 110. A light beam from an object that passes through the imaging optical system forms an image on an image sensor 162 provided in the camera 150.

A lens CPU 102 provided in the interchangeable lens 101 serves as a lens controller and stores characteristic information and optical information unique to the interchangeable lens 101 in an unillustrated internal memory. The lens CPU 102 also stores output setting values for actuators in a focus lens drive circuit 112, a zoom lens drive circuit 126, an aperture drive circuit 115, and an image stabilization (IS) drive circuit 116.

The lens CPU 102 transmits the characteristic information and optical information to a camera CPU 151 provided in the camera 150 that serves as a camera controller via the communication terminals 104 and 153. The characteristic information includes the name of the interchangeable lens 101 (ID for identifying an individual model), a maximum communication speed, a minimum F-number (maximum aperture), whether or not it is a zoom lens, a supported AF system, an image height which AF supports, and other information. The optical information includes information on the focus sensitivity according to a position of the focus lens 107, a position of the zoom lens (magnification varying lens) 108, and an aperture diameter (F-number) of the aperture stop 109, and the like, a focus correction amount (designed value), a focus correction manufacturing error value, and the like. The focus sensitivity is a value regarding a moving amount of the image plane relative to a unit moving amount of the focus lens 107.

The interchangeable lens 101 includes an MF drive user interface (UI) 122. In a case where the MF drive UI 122 is operated by the user, the camera CPU 151 detects the operation via the lens CPU 102 and transmits a permit signal to the lens CPU 102 to permit driving of the focus lens 107.

The lens CPU 102 and the camera CPU 151 communicate information such as various operation states, setting states, various information request commands (transmission requests), and drive commands via the communication terminals 104 and 153.

The interchangeable lens 101 includes an AF/MF selecting switch 130, a focus limit setting switch 131 as a first operation unit, and a focus limit start switch 132 and an IS switch 133 as a second operation unit, each of which is operable by the user. The interchangeable lens 101 can select the AF mode or the MF mode, and the AF/MF selecting switch 130 is a switch that allows the user to select one of the AF mode and the MF mode.

The focus limit setting switch 131 is provided to allow the user to select one of a normal focus mode (first mode) and a focus limit mode (second mode). The normal focus mode is a mode for setting a driving range of the focus lens 107 (referred to as the focus driving range hereinafter) to the entire movable range (first range) of the focus lens 107. The focus limit mode is a mode for setting the focus driving range to a part (second range) of the movable range of the focus lens 107. The focus limit start switch 132 is provided so that the user can instruct the start and stop of the focus limit operation that limits the focus driving range in the focus limit mode.

The IS switch 133 is provided so that the user can select whether or not to perform an IS operation, which will be described later. The states of these switches 130 to 132 are transmitted from the lens CPU 102 to the camera CPU 151 via the communication terminals 104 and 153.

The camera 150 includes a release switch 165, a camera UI 161, an AF start switch 167, an image sensor 162, and a shutter 163.

The release switch 165 is provided so that the user can start an imaging preparation operation by half-pressing the release switch 165 and start an imaging operation by fully pressing the release switch 165. The camera UI 161 is operable by the user to select various imaging modes and various setting values.

The AF start switch 167 is operable by the user to instruct the start of the AF operation (driving the focus lens 107 by AF) separately from the half-press operation of the release switch 165.

The function of the AF start switch 167 may be provided to a line-of-sight (visual line) detecting device in the viewfinder through which the user peeps. For example, in a case where the user gazes at one of a plurality of focus detecting areas in a viewfinder screen, the line-of-sight detecting device may detect a line of sight at that time and treat it as a command (or instruction) to start the AF operation for the gazed focus detecting area.

The image sensor 162 is a photoelectric conversion element such as a CCD sensor or a CMOS sensor, and photoelectrically converts (captures) an object image formed by the imaging optical system and outputs an imaging signal and a pair of focus detecting signals described later. The camera CPU 151 performs various image processing for the imaging signal to generate an image signal (image data). The image data is displayed on a rear monitor 164, or is recorded in an unillustrated recording medium as a still or moving image for recording according to a full pressing operation of the release switch 165 or the operation of an unillustrated recording switch.

The camera CPU 151 starts an AF operation when the AF mode is selected by the AF/MF selecting switch 130 and detects a half-press operation of the release switch 165 or an operation of the AF start switch 167 included in the camera UI 161.

In the AF operation, the camera CPU 151 performs image-plane phase-difference detecting AF using the image sensor 162 as an AF sensor. More specifically, the camera CPU 151 obtains a defocus amount from a phase difference between a pair of focus detecting signals output from the image sensor 162, and calculates a drive amount of the focus lens 107 to obtain an in-focus state based on the defocus amount. Then, the camera CPU 151 transmits a focus command including the drive amount to the lens CPU 102. The lens CPU 102 controls the focus lens drive circuit 112 according to the focus command to drive the focus lens 107. The position of the focus lens 107 driven in this manner is detected by the focus lens position sensor 111.

In a case where a defocus amount cannot be obtained at the position of the focus lens 107 at the start of the AF operation, the camera CPU 151 instructs the lens CPU 102 to perform a search operation. As the search operation, the lens CPU 102 drives the focus lens 107 in the infinity direction or the close-distance direction to a position where the defocus amount can be obtained.

The MF drive UI 122 of the interchangeable lens 101 includes an MF ring that is provided on the outer circumference of the interchangeable lens 101 rotatably around the optical axis. When the user rotates the MF ring (manual operation) while the MF mode is selected by the AF/MF selecting switch 130, a rotating amount is detected by a rotation detecting sensor 123. The lens CPU 102 controls the focus lens drive circuit 112 according to the detected rotating amount of the MF ring to drive the focus lens 107. Thereby, MF is performed. In a case where MF is selected by the AF/MF selecting switch 130, the camera CPU 151 does not perform the AF operation.

The zoom drive UI 122 in the interchangeable lens 101 includes a manual zoom (MZ) ring that is provided on the outer circumference of the interchangeable lens 101 rotatably around the optical axis. In a case where the user rotates the MF ring, a rotating amount is detected by a rotation detecting sensor 125. The lens CPU 102 controls the zoom lens drive circuit 126 according to the detected rotating amount of the MZ ring, and drives the zoom lens 108. Thereby, MZ is performed. The position of the zoom lens 108 is detected by a zoom lens position sensor 127.

The camera CPU 151 obtains luminance information on an object from an imaging signal or image data, and performs an auto-exposure (AE) operation based on the luminance information according to a half-press operation of the release switch 165. Thereby, the shutter speed of the shutter 163 that controls the exposure of the image sensor 162 and an F-number (aperture value) of the aperture stop 109 are calculated, and an aperture command including the F-number is sent to the lens CPU 102. The lens CPU 102 controls the aperture drive circuit 115 based on the aperture command, and operates the aperture stop 109. The positions of the aperture blades (aperture value) of the aperture stop 109 are detected by the aperture position sensor 114.

The camera CPU 151 transmits an IS start command to the lens CPU 102 according to a half-press operation of the release switch 165. In a case where the lens CPU 102 receives an IS start command while the IS switch 133 is turned on, the lens CPU 102 acquires a shake signal corresponding to camera shake such as a handheld shake from a shake detector 119 including a gyro sensor or the like. Based on the shake signal, the lens CPU 102 controls the IS drive circuit 116 to shift the correction lens 110 relative to the optical axis so as to reduce (correct) image blur caused by the camera shake. Thus, the IS operation is performed. In a case where no IS operation is performed, the lens CPU 102 controls a lock drive circuit 117 to drive a mechanical lock 118, and locks and holds the correction lens 110 at a neutral position on the optical axis.

A description will now be given of the focus limit operation according to this embodiment. In the following description, a focus limit will be sometimes referred to as FL. The start and stop of the FL operation will be sometimes referred to as an FL start and FL stop, respectively.

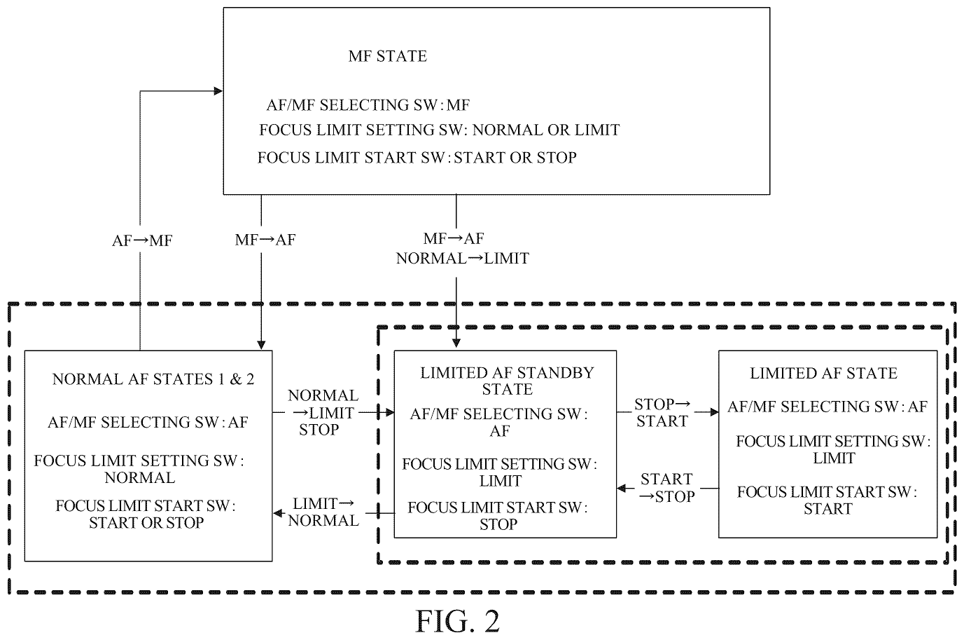

FIG. 2 illustrates the transition of focus states. The interchangeable lens 101 according to this embodiment has the following five focus states. The MF state is a state in which the focus lens 107 is driven according to the operation of the MF ring.

A normal AF state 1 is a state in which the focus driving range is the entire movable range of the focus lens 107.

A normal AF state 2 is a state in which the focus driving range is the entire movable range of the focus lens 107, similarly to the normal AF state 1, but in a case where an FL stop is instructed by the FL start switch 132, this state transitions to a limited AF standby state, which will be described next.

The limited AF standby state is a state in which the focus driving range is the entire movable range of the focus lens 107, similarly to the normal AF states 1 and 2, but in a case where an FL start is instructed by the FL start switch 132, this state transitions to a limited AF state, which will be described next.

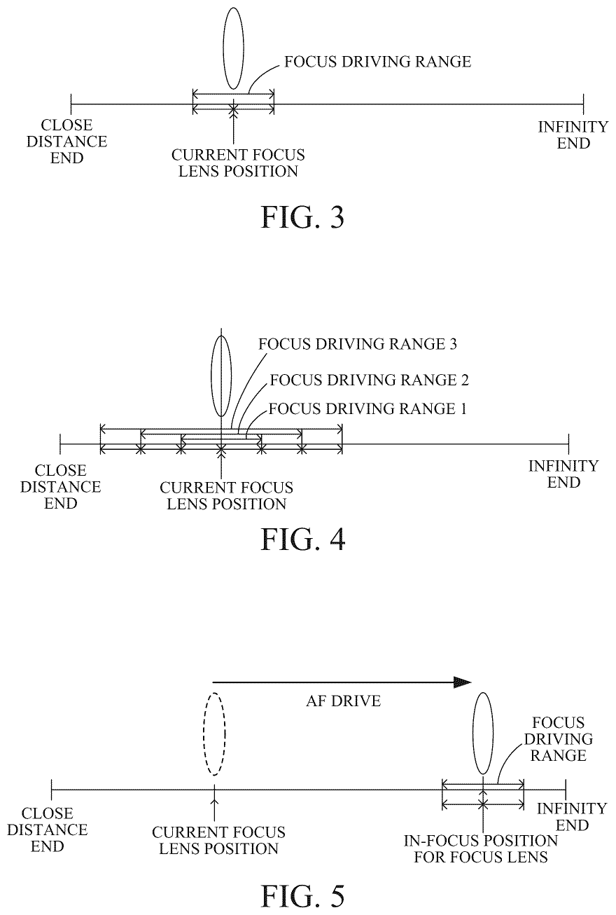

As illustrated in FIG. 3, the limited AF state is a state for setting a position of the focus lens 107 when the FL start command is issued (present) to a reference position, and for limiting a focus driving range to a (second) range having both end positions apart from the reference position in the infinity direction and the close distance direction by a predetermined distance. As mentioned above, the focus driving range at this time is narrower than the entire movable range (first range) of the focus lens 107.

A description will now be given of the transitions among the five focus states. In a case where the MF mode is selected by the AF/MF selecting switch 130 in the four focus states except the MF state, a focus state transitions to the MF state. In a case where the MF mode is selected by the AF/MF selecting switch 130 while the focus lens 107 is being driven in the AF operation, the drive of the focus lens 107 is stopped and this state transitions to the MF state.

A description will be given of the transition of the focus state from the MF state. In a case where the AF mode is selected by the AF/MF selecting switch 130 in the MF state, the normal focus mode is selected by the FL setting switch 131, and an FL stop is instructed by the FL start switch 132, the focus state transitions to the normal AF state 1.

In a case where the AF mode is selected by the AF/MF selecting switch 130 in the MF state, the FL mode is selected by the FL setting switch 131, and an FL stop is instructed by the FL start switch 132, the focus state transitions to the limited AF standby state.

In a case where the AF mode is selected by the AF/MF selecting switch 130 in the MF state, the FL mode is selected by the FL setting switch 131, and an FL start is instructed by the FL start switch 132, the focus state transitions to the normal AF state 2.

A description will now be given of the transition of the focus state from the normal AF state 1. In a case where the FL mode is selected by the FL setting switch 131 in the normal AF state 1, and an FL stop is instructed by the FL start switch 132, the focus state transitions to the limited AF standby state.

In a case where the FL mode is selected by the FL setting switch 131 in the normal AF state 1, and an FL start is instructed by the FL start switch 132, the focus state transitions to the normal AF state 2.

A description will now be given of the transition of the focus state from the normal AF state 2. In a case where the normal focus mode is selected by the FL setting switch 131 in the normal AF state 2, the focus state transitions to the normal AF state 1.

In a case where a stop of the FL operation is instructed by the FL start switch 132 in the normal AF state 2, the focus state transitions to the limited AF standby state.

A description will now be given of the transition of the focus state between the limited AF standby state and the limited AF state. In any one of the limited AF standby state and the limited AF state, in a case where the normal focus mode is selected by the FL setting switch 131, the focus state transitions to the normal AF state 1. In a case where an FL start is instructed by the FL start switch 132, the focus state becomes the limited AF state, and in a case where an FL stop is instructed by the FL start switch 132, the focus state becomes the limited AF standby state.

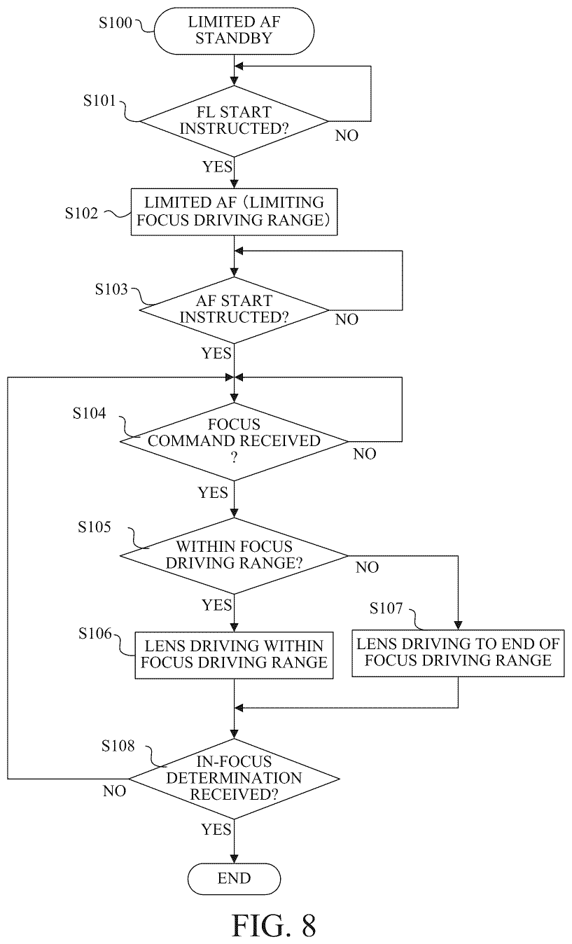

A description will now be given of processing (control method) in the limited AF state using the flowchart in FIG. 8. This processing is executed according to a program by the lens CPU 102, which serves as a computer (control unit) that controls driving of the focus lens 107.

In step S100, the lens CPU 102 transitions the focus state to a limited AF standby state by selecting the FL mode with the FL setting switch 131 in the AF mode. Then, in a case where an FL start is instructed from the AF standby state by the FL start switch 132, the lens CPU 102 transitions the focus state to a limited AF state in step S101.

In step S102 in the limited AF state, the lens CPU 102 limits the focus driving range by setting the position of the focus lens 107 when the FL start is instructed, to a reference position. In other words, the FL operation is started.

In a case where the start of the AF operation is instructed by half-pressing the release switch 165 or operating the AF start switch 167 in step S103, the lens CPU 102 waits to receive a focus command from the camera CPU 151 in step S104. The camera CPU 151 performs focus detection using a pair of focus detecting signals from the image sensor 162, and if a defocus amount is obtained, the camera CPU 151 calculates a drive amount of the focus lens 107 and sends a focus command including the drive amount to the lens CPU 102.

In step S105, the lens CPU 102 that has received a focus command determines whether or not a target position of the focus lens 107 is a position within a focus driving range limited by the FL operation in a case where the focus lens 107 is driven by the drive amount included in the focus command received from the camera CPU 151. In a case where the target position is within the limited focus driving range, the lens CPU 102 drives the focus lens 107 by the drive amount received from the camera CPU 151 in step S106. On the other hand, in a case where the target position is outside the limited focus driving range, in step S107, the lens CPU 102 drives the focus lens 107 to an end position of the focus driving range in a direction of the drive amount received from the camera CPU 151 and stops the focus lens 107.

The lens CPU 102 that has driven the focus lens 102 in step S106 or S107, determines in step S108 whether or not it has received an in-focus determination notification from the camera CPU 108. In a case where it has received the in-focus determination notification, the flow ends, and in a case where it has not received the focus determination notification, the flow proceeds to step S104 and waits for the reception of a new focus command from the camera CPU 151.

A description will now be given of a focus driving range limited in the limited AF state. The focus driving range in the limited AF state can be changed according to a user input via an input member such as a slide switch or dial switch included in the lens UI 134 provided on the interchangeable lens 101. For example, as illustrated in FIG. 4, there is a method of changing the focus driving range (1 to 3) by a drive amount corresponding to a multiplication of a predetermined reference amount, more specifically, 1Fδ, which is a depth of field (where F is an F-number, and δ is a permissible circle of confusion diameter). Also, the user may input a reference amount and both end positions of a focus driving range from the lens UI 134. The focus driving range may be changed by transmitting information such as a reference amount and both end positions input from the camera UI 161 to the lens CPU 102.

The further limited focus driving range may be changed according to the focal length of the imaging optical system changed by the movement of the zoom lens 108 and the F-number set by the aperture stop 109. For example, a focal length can be obtained from the position of the zoom lens 108 detected through the zoom lens position sensor 127, or an F-number can be obtained from the output of the aperture position sensor 114. Thereby, a focus driving range can be set according to a focal length and an F-number.

### Second Embodiment

A description will now be given of a second embodiment. The configuration of a camera system according to the second embodiment is the same as that of the first embodiment. The transition of the focus state is also the same as that of the first embodiment.

In this embodiment, in the limited AF state, as illustrated in FIG. 5, the focus driving range is limited by setting as a reference position an in-focus position of the focus lens 107 driven by the first AF operation first executed after the (present) time when the FL start is instructed by the FL start switch 132. The camera CPU 151 performs an in-focus determination that determines whether or not the in-focus state has been obtained by driving the focus lens 107. In a case where the in-focus state is obtained, the camera CPU 151 notifies the lens CPU 102 of the in-focus determination result. In a case where the lens CPU 102 receives the notification of the in-focus determination result from the camera CPU 151, the lens CPU 102 sets the limited focus driving range by setting the position of the focus lens 107 at that time as the reference position.

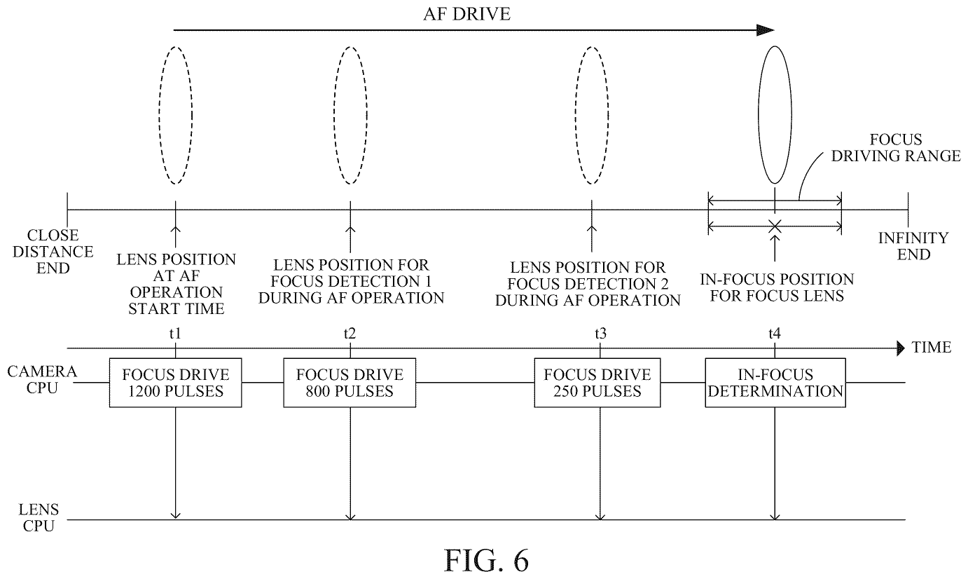

FIG. 6 illustrates the position of the focus lens 107 during the AF operation and the communication between the camera CPU 151 and the lens CPU 102. The AF operation starts at time t1 and ends at time t4. At times t2 and t3, the camera CPU 151 again performs focus detection, and transmits to the lens CPU 102 a focus command in which the drive amount of the focus lens 107 is updated based on the defocus amount obtained at each time. FIG. 6 illustrates an example in which a drive amount as a driving pulse number of a stepping motor in the focus lens drive circuit 112 is updated to 1200 pulses for the focus command at time t1, 800 pulses for the focus command at time t2, and 250 pulses for the focus command at time t3.

At time t4, the lens CPU 102 receives the in-focus determination notification from the camera CPU 151, and sets a limited focus driving range based on the in-focus position stopped at that time.

In addition, at time t4, the lens CPU 102 may determine the in-focus position of the focus lens 107 by the following method, regardless of the in-focus determination notification from the camera CPU 151.

(1) As illustrated in FIG. 6, during the AF operation, a plurality of focus commands (drive commands) are transmitted from the camera CPU 151 to the lens CPU 102. Also, the focus lens 107 may be stopped once and an in-focus determination may be made, and if the in-focus state is not achieved, a focus command to drive the focus lens 107 again may be sent.

Accordingly, if a focus command is not sent from the camera CPU 151 for a period longer than a predetermined time, the lens CPU 102 may determine that the position of the focus lens 107 at that time is an in-focus position.

(2) As illustrated in FIG. 6, during the AF operation, the camera CPU 151 repeatedly performs focus detection to update the in-focus position (the drive amount of the focus lens 107). This is because the focus lens 107 can be driven to a more accurate in-focus position by performing focus detection at a position closer to the in-focus position.

Accordingly, when the drive amount of the focus lens 107 included in the focus command from the camera CPU 151 becomes smaller than a predetermined amount, the lens CPU 102 may determine that the target position reached by that drive amount is the in-focus position. Thereby, an in-focus position can be determined from a focus detection result at a position closer to the in-focus position.

### Third Embodiment

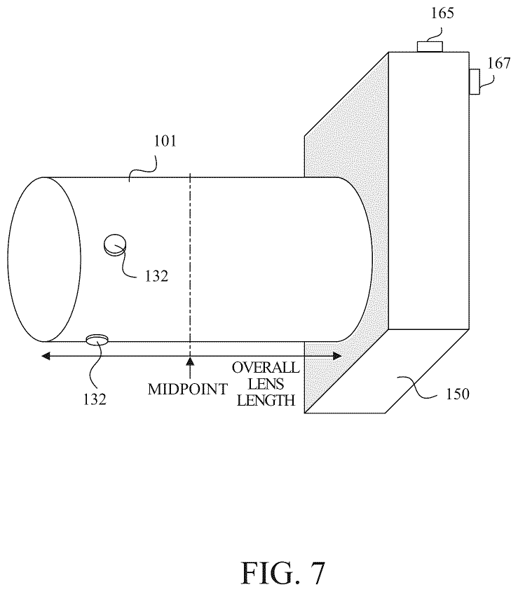

FIG. 7 illustrates the arrangement of the FL start switch 132 in the interchangeable lens 101 according to a third embodiment. FIG. 7 illustrates two candidate positions for arranging the FL start switch 132 on the outer surface of a barrel portion that houses the imaging optical system in the interchangeable lens 101. A lens unit closest to an object in the imaging optical system is disposed near the front end of the barrel portion, and a lens-side mount is provided at the rear end of the barrel portion.

As illustrated in FIG. 7, the FL start switch 132 is disposed on the object side of a position corresponding to half of the overall length (midpoint) of the barrel portion in the optical axis direction. In other words, the FL start switch 132 is disposed at a position closer to an end on the object side than an end on the image side of the barrel portion of the interchangeable lens 101.

In a case where the user holds the camera 150 in a normal orientation, the two candidate positions are located at a position on the lower side and a position on the left side facing the object side. The position on the lower side and the position on the left side in a case where the user holds the camera 150 in the normal orientation are positions where the FL start switch 132 can be easily operated with the user's left hand that holds the interchangeable lens 101.

Also, in the normal orientation, the FL start switch 132 may be disposed at a position on the upper side or on the right side facing the object.

Each embodiment can easily (quickly) limit the driving range of the focus lens in AF while reducing the risk of erroneous operation.

In each embodiment, the FL start switch 132 is provided on the interchangeable lens 101 separately from the release switch 165, but the release switch 165 may have the function of the FL start switch. For example, a half-press operation of the release switch 165 may be treated as an FL start by the FL start switch, and another half-press operation may be treated as an FL stop by the FL start switch. Since the start of the AF operation can be instructed by operating the AF start switch 167 provided on the camera 150, the operation can be easily performed in a case where the release switch 165 provided on the same camera 150 has the function of the FL start switch.

The AF start switch 167 provided to the camera 150 in each embodiment may be provided to the interchangeable lens 101. Even in this case, the AF start switch 167 may be provided at the same position as that of the FL start switch 132 (although the AF start switch 167 is located at a position or has a shape that is different from that of the FL start switch 132).

In each embodiment, the optical apparatus is an interchangeable lens (lens apparatus) attachable to a lens interchangeable type camera, but the optical apparatus may be a lens integrated type camera having an integrated imaging optical system. Even in this case, the FL setting switch 131 and the FL start switch 132 are provided on the outer surface of the barrel portion that houses the imaging optical system.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can easily limit a driving range of a focus lens during AF while reducing the risk of erroneous operation.

This application claims priority to Japanese Patent Application No. 2023-200799, which was filed on Nov. 28, 2023 and which is hereby incorporated by reference herein in its entirety.

What is claimed is:

1. An optical apparatus comprising:
a first operation unit operable to switch between a first mode for setting a driving range of a focus lens in autofocus to a first range and a second mode for setting the driving range of the focus lens in the autofocus to a second range narrower than the first range;
a second operation unit operable to issue a start command of a focus limit operation for limiting the driving range to the second range in the second mode; and
a processor configured to:
set the second range to a range that has a reference position at a position of the focus lens when the start command is issued or a position to which the focus lens is driven by the autofocus after the start command is issued, according to the start command in a case where the focus lens can be driven by the autofocus and the second mode is set, and
control driving of the focus lens by the autofocus within the second range after the second range is set.

2. The optical apparatus according to claim 1, wherein the autofocus performs a search operation that moves the focus lens within the driving range to obtain a defocus amount.

3. The optical apparatus according to claim 1, wherein the processor is configured to change the second range based on a user input.

4. The optical apparatus according to claim 1, wherein the second range is a range from the reference position to a position that corresponds to a drive amount of the focus lens that is a multiplication of a depth of field.

5. The optical apparatus according to claim 1, wherein the second range is a range from the reference position to a position that corresponds to at least one of an F-number and a focal length of an imaging optical system including the focus lens.

6. The optical apparatus according to claim 1, wherein the optical apparatus is a lens apparatus attachable to and detachable from an image pickup apparatus, and the image pickup apparatus performs in-focus determination in the autofocus, and
wherein the processor is configured to set the reference position based on a result of the in-focus determination transmitted from the image pickup apparatus.

7. The optical apparatus according to claim 1, wherein the optical apparatus is a lens apparatus attachable to and detachable from an image pickup apparatus, and the image pickup apparatus transmits a drive amount of the focus lens in the autofocus to the optical apparatus, and
wherein the processor is configured to set the position of the focus lens to the reference position when the drive amount transmitted from the image pickup apparatus becomes smaller than a predetermined amount.

8. The optical apparatus according to claim 1, wherein the optical apparatus is a lens apparatus attachable to and detachable from an image pickup apparatus, and the image pickup apparatus repeatedly transmits a drive command for the focus lens in the autofocus to the optical apparatus until an in-focus state is obtained, and
wherein the processor is configured to set the position of the focus lens to the reference position when a period during which the drive command is not received from the image pickup apparatus becomes longer than a predetermined time.

9. The optical apparatus according to claim 1, wherein the first operation unit is disposed on a barrel portion that houses an imaging optical system including the focus lens, at a position closer to an end on an object side than to an end on an image side.

10. The optical apparatus according to claim 9, wherein the first operation unit is disposed on the barrel portion, at a position on a lower side or on a left side facing an object in a normal orientation.

11. A control method for an optical apparatus that includes a first operation unit operable to switch between a first mode for setting a driving range of a focus lens in autofocus to a first range and a second mode for setting the driving range of the focus lens in the autofocus to a second range narrower than the first range, and a second operation unit operable to issue a start command of a focus limit operation for limiting the driving range to the second range in the second mode, the control method comprising:
setting the second range to a range that has a reference position at a position of the focus lens when the start command is issued or a position to which the focus lens is driven by the autofocus after the start command is issued, according to the start command in a case where the focus lens can be driven by the autofocus and the second mode is set; and
controlling driving of the focus lens by the autofocus within the second range after the second range is set.

12. A non-transitory computer-readable storage medium storing computer-executable instructions for causing a computer to execute a control method for an optical apparatus that includes a first operation unit operable to switch between a first mode for setting a driving range of a focus lens in autofocus to a first range and a second mode for setting the driving range of the focus lens in the autofocus to a second range narrower than the first range, and a second operation unit operable to issue a start command of a focus limit operation for limiting the driving range to the second range in the second mode, the control method comprising:
setting the second range to a range that has a reference position at a position of the focus lens when the start command is issued or a position to which the focus lens is driven by the autofocus after the start command is issued, according to the start command in a case where the focus lens can be driven by the autofocus and the second mode is set; and
controlling driving of the focus lens by the autofocus within the second range after the second range is set.
